(19) United States
(12) Patent Application Publication
(10) Pub. No.: US 2026/0117909 A1
(43) Pub. Date: Apr. 30, 2026

(54) PIPE FLANGE LEAK CONTAINMENT ASSEMBLY

(71) Applicant: Andax Industries, L.L.C., Saint Marys, KS (US)

(72) Inventors: Patrick F. McAtarian, Saint Marys, KS (US); Mark McAtarian, Saint Marys, KS (US)

(73) Assignee: Andax Industries, L.L.C., Saint Marys, KS (US)

(21) Appl. No.: 18/999,937

(22) Filed: Dec. 23, 2024

Related U.S. Application Data
(60) Provisional application No. 63/711,531, filed on Oct. 24, 2024.

(51) Int. Cl. F16L 55/07; F16L 23/00

(52) U.S. Cl. CPC F16L 55/07; F16L 23/006

(57) ABSTRACT

A pipe leak containment assembly includes a housing having a pair of opposed ends defining a containment region therebetween. Each end is configured to circumscribe a respective one of the sections of a pipe, such that the housing is secured relative to the pipe and a connection interface defined between the pipe sections is disposed in the containment region. The housing defines a first plurality of arcuately arranged darting edges each extending from an origin to an apex. The apex is spaced from the first one of the ends. The origin is disposed at or nearer to the first one of the ends relative to the apex. The housing has a first perimeter at the apices and a second perimeter at the origins. Adjacent pairs of the darting edges engage each other such that the first perimeter is larger than the second perimeter.

### CROSS-REFERENCE TO RELATED APPLICATIONS

The present application claims priority from U.S. Provisional Patent Application No. 63/711,531, filed Oct. 24, 2024, and entitled PIPE FLANGE LEAK CONTAINMENT ASSEMBLY, the entire disclosure of which is hereby incorporated by reference herein.

### BACKGROUND OF THE INVENTION

### 1. Field of the Invention

The present invention relates generally to an assembly for containing a leak from a pipe connection interface.

### 2. Discussion of the Prior Art

A conventional pipe may include a pair of pipe sections joined at a connection interface, such as a flanged interface or other joint. Leakage at the interface may occur, with the substance being carried by the pipe leaking out therefrom. Such a leak may drip or otherwise escape out into the environment in an uncontrolled, uncharacterized, and/or unmonitored manner, making it difficult for the severity of the leak and/or changes thereto to be readily ascertained. For instance, due to the uncontrolled manner of leakage, one cannot determine whether the leak is high or low volume, critical or non-critical, etc. It is therefore difficult to determine what course of action is appropriate to rectify the situation. For instance, a high-volume leak in a critical pipeline carrying a highly toxic substance might necessitate shut-down and immediate repair, whereas a slow leak in a low-priority line carrying an environmentally acceptable substance might allow for operations to continue for some time before the leak is fixed.

### SUMMARY

According to one aspect of the present invention, a pipe leak containment assembly is operable to contain a leak from a pipe. The pipe includes a pair of pipe sections joined at a connection interface. The pipe leak containment assembly comprises a housing. The housing includes a pair of opposed ends defining a containment region therebetween. Each of the ends is configured to circumscribe a respective one of the pipe sections, such that the housing is secured relative to the pipe and the connection interface is disposed in the containment region. The housing defines a first plurality of arcuately arranged darting edges each extending from an origin to an apex, wherein the apex is spaced from a first one of the ends, and the origin is disposed at or nearer to the first one of the ends relative to the apex. The housing has a first perimeter at the apices and a second perimeter at the origins. Adjacent pairs of the darting edges engage each other such that the first perimeter is larger than the second perimeter.

According to another aspect of the present invention, a method of containing a leak from a pipe comprises the steps of: (a) wrapping a housing about the pipe to at least substantially circumscribe the pipe; (b) sealing the housing to itself such that the housing fully circumscribes the pipe and the pipe extends through a containment region defined by the housing; (c) securing at least one of the longitudinally opposed ends of the housing relative to the pipe such that a pipe leak location is disposed in the containment region; and (d) heat-shrinking the housing about the pipe.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a top perspective view of a pipe and a pipe leak containment assembly in accordance with a preferred embodiment of the present invention;

FIG. 2 is a bottom perspective view of the pipe and the pipe leak containment assembly of FIG. 1;

FIG. 3 is a cross-sectional side view of the pipe and the pipe leak containment assembly of FIGS. 1 and 2;

FIG. 4 is an interior view of the pipe leak containment assembly of FIGS. 1-3 prior to construction, wherein the assembly is in the form of a flat sheet;

FIG. 5 is a perspective view of the interior of the pipe leak containment assembly of FIGS. 1-4, in a partially constructed state and prior to wrapping about the pipe;

FIG. 6 is a perspective view of the pipe of FIGS. 1-3 and the pipe leak containment assembly as shown in FIG. 5, with the pipe leak containment assembly being partially wrapped about the pipe;

FIG. 7 is a top perspective view of the pipe and the pipe leak containment assembly of FIGS. 1-3 and 6 after heat-shrinking;

FIG. 8 is an exterior view of a housing of a pipe leak containment assembly in accordance with a second preferred embodiment of the present invention, prior to construction, with the housing in the form of a flat sheet;

FIG. 9 is an enlarged view of a reinforcement system secured to an end of the housing of FIG. 8;

FIG. 10 is a schematic cross-sectional view of a pipe and the housing of FIGS. 8 and 9 in a first stage of wrapping of the housing about the pipe, wherein the housing tab is retained relative to the pipe while wrapping the remainder of the housing about the pipe commences;

FIG. 11 is a schematic cross-sectional view similar to FIG. 10, but depicting a second stage of wrapping of the housing about the pipe, wherein one revolution of the housing is complete and complementary interengaging elements disposed on the housing have engaged one another;

FIG. 12 is a schematic cross-sectional view similar to FIGS. 10 and 11, but depicting a third stage of wrapping of the housing about the pipe, wherein a large, arcuately extending overlapping region of the housing is defined;

FIG. 13 is an enlarged perspective view of the pipe leak containment assembly of FIGS. 8-12 and of the pipe of FIGS. 10-12, particularly illustrating wrapping of the securement strap of the reinforcement system; and

FIG. 14 is an exterior view of a housing of a pipe leak containment assembly in accordance with a third preferred embodiment of the present invention, prior to construction, wherein the housing is in the form of discrete segments.

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

Furthermore, unless specified or made clear, the directional references made herein with regard to the present invention and/or associated components (e.g., top, bottom, upper, lower, inner, outer, etc.) are used solely for the sake of convenience and should be understood only in relation to each other. For instance, a component might in practice be oriented such that faces referred to as “top” and “bottom” are sideways, angled, inverted, etc. relative to the chosen frame of reference.

### Embodiment 1: Single-Wrap Sheet with Straight Darting Edges

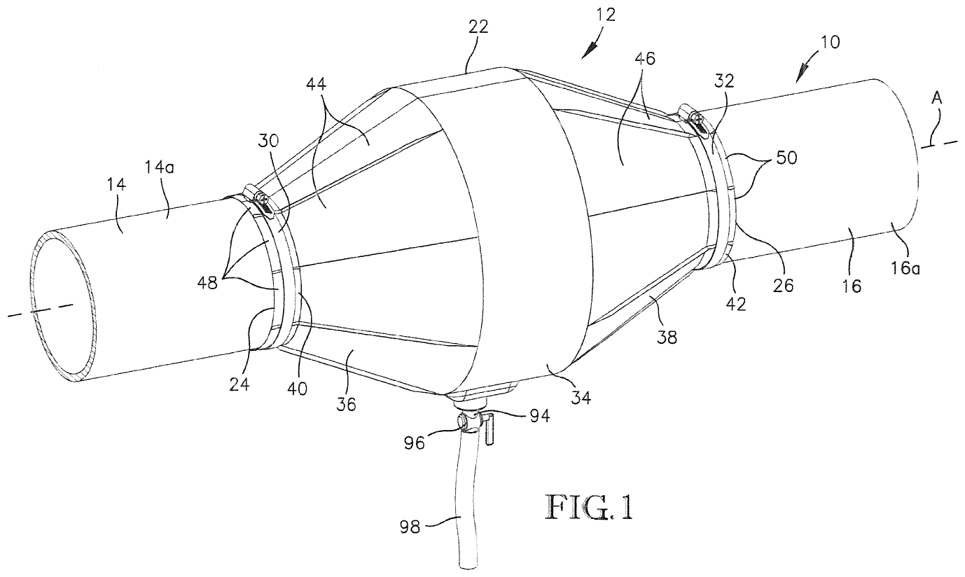

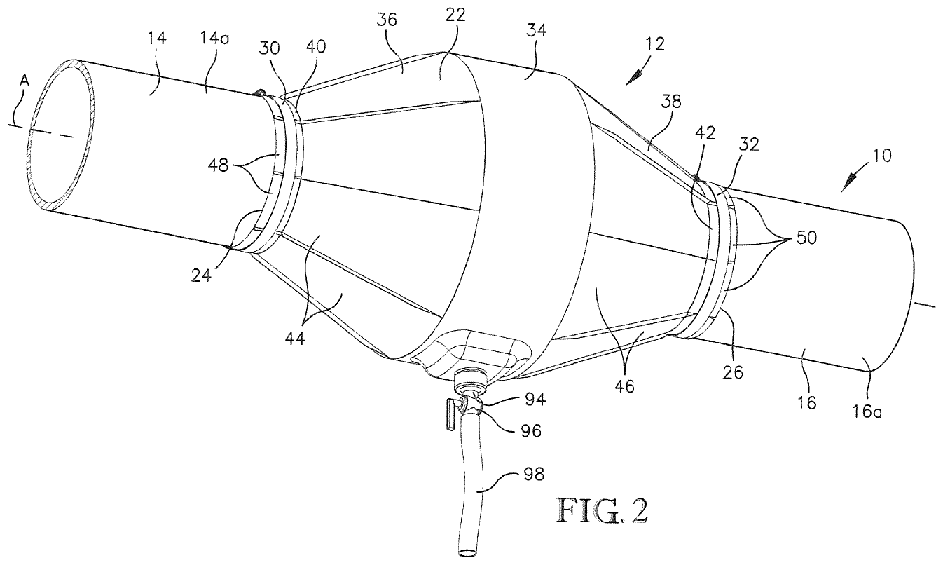

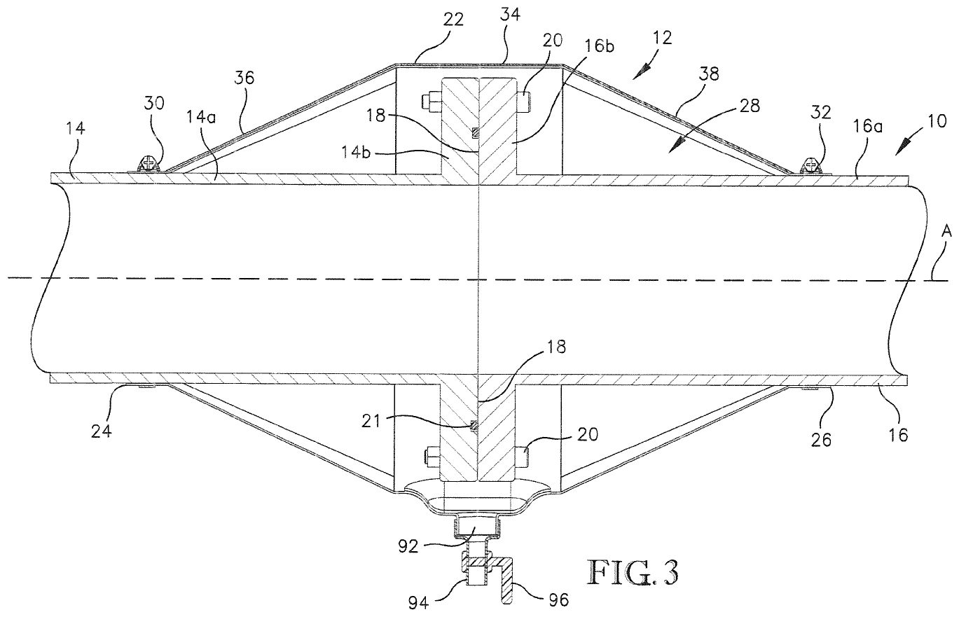

With initial reference to FIGS. 1-3, a pipe 10 and a pipe leak containment assembly 12 are illustrated.

### Pipe

The pipe 10 includes a pair of pipe sections 14 and 16 each extending along a shared pipe axis or longitudinal axis A and abutting each other along a connection interface 18. More particularly, each pipe section 14 and 16 includes a respective tubular main body 14a or 16a and an annular flange 14b or 16b extending radially outwardly from and circumscribing the corresponding main body 14a or 16a. Fasteners 20 extend through both flanges 14b and 16b to secure them relative to each other, and a gasket 21 is embedded in the flange 14b to seal the connection interface 18. Variations in the connection interface fall within the scope of some aspects of the present invention, however. For instance, whereas the illustrated interface 18 is at least substantially planar, an irregular interface could be provided. Multiple gaskets could be present, or gaskets could be omitted. Adhesives could be used in lieu of or in addition to fasteners, or magnets could be provided. Yet further, the connection interface may alternatively be formed of a non-flanged connection, such as an abutting/end-to-end, overlapping, or telescopic tube connection.

Although the illustrated pipe section main bodies 14a and 16a are circular in cross-section, it is noted that non-circular pipe section main bodies fall within the scope of some aspects of the present invention. For instance, either or both pipe section main bodies could have a polygonal cross section. Furthermore, either or both flanges could be polygonal or otherwise non-circular, in contrast to the illustrated circularity of the flanges 14b and 16b.

### Pipe Leak Containment Assembly Overview

The pipe leak containment assembly 12 is mounted to the pipe 10. More particularly, the pipe leak containment assembly 12 includes a housing 22 including a pair of longitudinally opposed ends 24 and 26. The ends 24 and 26 define the containment region 28 therebetween. The pipe leak containment assembly 12 is mounted to the pipe 10 such that the ends 24 and 26 circumscribe the respective ones of the pipe sections 14 and 16 and the connection interface 18 is disposed in the containment region 28.

In greater detail still, the in the illustrated embodiment, a pair of clamps 30 and 32 adjacent the respective ends 24 and 26 encircle and secure the housing 22 to the respective main bodies 14a and 16b. A portion of each main body 14a and 16b and the entireties of the flanges 14b and 16b (and, in turn, the connection interface 18) are thus disposed between the ends 24 and 26 and in the containment region 28.

The housing 22 is preferably tapered at the ends 24 and 26 and expanded or enlarged therebetween. More particularly, as will be discussed in greater detail below, the housing 22 preferably includes a center band 34, first and second transition regions 36 and 38 disposed on axially opposed sides of the center band 34, and first and second end bands 40 and 42 abutting the corresponding transition regions 36 and 38, respectively. The end bands 40 and 42 define the previously mentioned ends 24 and 26, respectively.

As best shown in FIGS. 1-3, the center band 34 is preferably cylindrical in form and configured to encircle or circumscribe the flanges 14b and 16b and, in turn, the connection interface 18. Non-cylindrical forms, including polygonal forms, fall within the scope of some aspects of the present invention, however.

Preferably, the center band 34 extends continuously or at least substantially continuously and is non-segmented in form. Discontinuities and/or segmentation are permissible according to some aspects of the present invention, however.

The transition regions 36 and 38 preferably contract gradually as they extend away from the center band 34 to the respective end bands 40 and 42.

More particularly, as will be discussed in greater detail below, the center band 34 preferably presents a center band perimeter; the transition regions 36 and 38 each preferably present respective transition region perimeters; and the end bands 40 and 42 each preferably present respective end band perimeters. Each transition region perimeter preferably progressively decreases in size from a maximum perimeter equal to that of the center band 34 to a minimum perimeter equal to that of the respective end band 40 or 42.

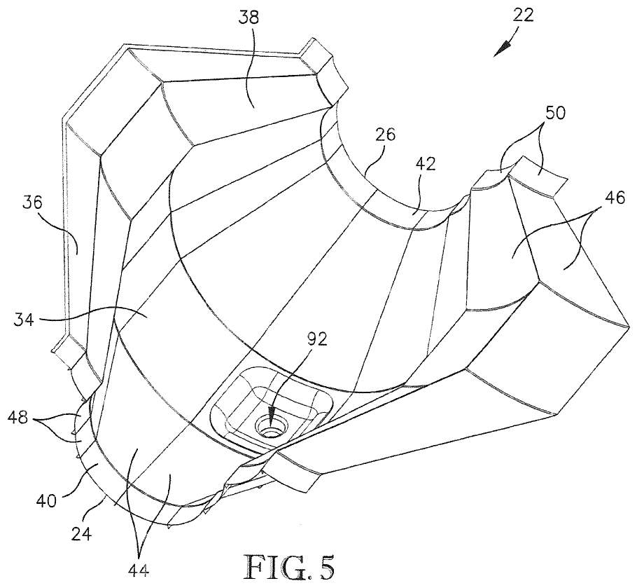

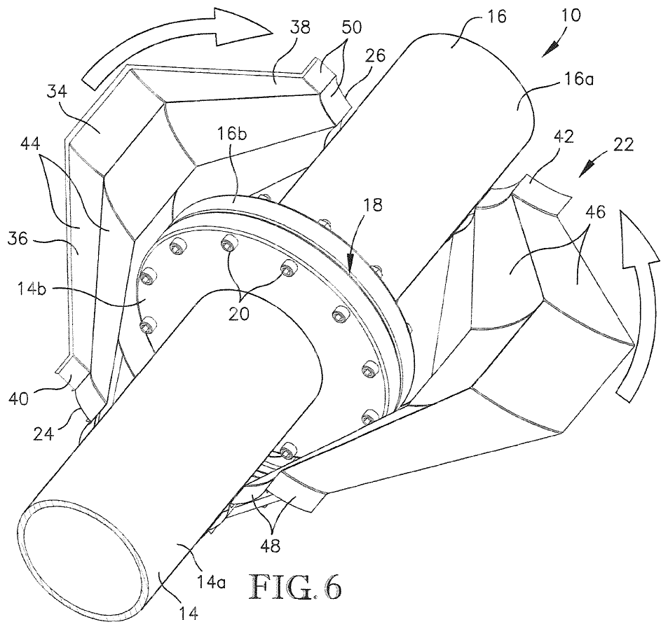

In the illustrated embodiment of FIGS. 1-7, such progressive decrease in perimeter is smooth or gradual. Even more particularly, the illustrated decrease is initially linear (prior to a deformation-inducing heat-shrinking process that will be described in greater detail below). However, it is permissible according to some aspects of the present invention for nonlinear variations in perimeter to occur, whether such variations are present both prior to and after heat shrinking or only after to such a process. In some embodiments, for instance, pipe features might dictate that an initially linear configuration is unsuitable and that a curved, stepped, or otherwise variable perimetrical variation is preferred.

### Housing

In the illustrated embodiment, the housing 22 in its installed configuration presents mirror symmetry across a plane orthogonal to the pipe axis A and disposed equidistantly between the opposed ends 24 and 26 (i.e., a plane extending through the center band 34). Alternatively stated, the opposing transition regions 36 and 38 preferably mirror each other, as do the opposing end bands 40 and 42

However, asymmetry is permissible without departing from the scope of some aspects of the present invention. Such asymmetry might be suitable if, for instance, a larger pipe section is joined with a smaller pipe section, with the end bands therefore preferably being sized differently from each other in accordance with the dissimilar pipe section diameters.

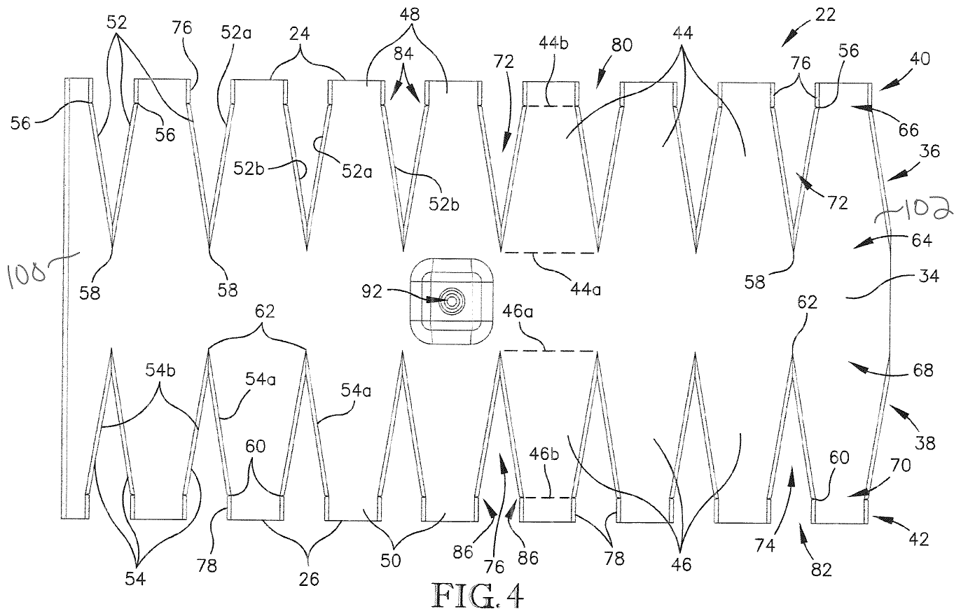

When the housing 22 is in a flat, uninstalled configuration, as shown in FIG. 4, the previously described symmetry is apparent across a lengthwise midline disposed equidistantly between the ends 24 and 26. Mirror symmetry across an orthogonal axis (i.e., running from an end 24 to an end 26 is not present, however. (Symmetry across an orthogonal axis is permissible, however.)

In a preferred embodiment of the present invention, each transition region 36 and 38 comprises a plurality of tapered transition segments 44 or 46, respectively. Similarly, each end band 40 or 42 comprises a respective plurality of end band segments 48 or 50.

As best shown in FIG. 4, the transition segments 44 and 46 are each preferably in the form of truncated triangles or wedges, expanding from a base 44a or 46a adjacent the center band 34 to a plateaued top 44b or 46b adjacent the corresponding end band segment 48 or 50.

As also illustrated in FIG. 4, the end band segments 48 and 50 are preferably rectangular in form and dimensioned to correspond to the tops 44b or 46b of the transition segments 44 and 46.

As will be apparent from FIG. 4, the housing 22 is preferably formed from a single flat sheet that is rolled up or folded into its final form (i.e., constructed). However, other formation or construction techniques fall within the scope of some aspects of the present invention.

Alternatively described, the housing 22 defines first and second pluralities of darting edges 52 and 54, respectively. Preferably, such darting edges 52 and 54 are all defined in the aforementioned single sheet and are present when the sheet is in a flat, pre-rolled or pre-folded form.

Each of the darting edges 52 of the first plurality extends from an origin 56 to an apex 58. When the containment assembly 12 is mounted to the pipe 10 or similar structure, the origin 56 and the apex 58 are preferably each disposed axially between the connection interface 18 and the first one of the ends 24, with the origin 56 being disposed nearer to the first one of the ends 24 than is the apex 58. Alternatively described, each apex 58 is preferably disposed at an interface 64 between the transition region 36 and the center band 34, whereas each origin 56 is disposed at an interface 66 between the transition region 36 and the first end band 40.

Characterized in yet another way, the apex 58 is preferably spaced from the first one of the ends 24. The origin 56 is disposed nearer to the first one of the ends 24 relative to the apex 58.

It is also permissible according to some aspects of the present invention for the origin to be disposed at the first end rather than being spaced inward therefrom. That is, the darting edge could permissibly extend all the way from the apex to the first end, with no end band being present.

Similarly, each of the darting edges 54 of the second plurality extends from an origin 60 to an apex 62. When the containment assembly 12 is mounted to the pipe 10 or similar structure, the origin 60 and the apex 62 are preferably each disposed between the connection interface 18 and the second one of the ends 26, with the origin 60 being disposed nearer to the second one of the ends 26 than is the apex 62. Alternatively described, each apex 62 is preferably disposed at an interface 68 between the transition region 38 and the center band 34, whereas each origin 60 is disposed at an interface 70 between the transition region 38 and the second end band 42.

Characterized in yet another way, the apex 62 is preferably spaced from the second one of the ends 26. The origin 60 is disposed nearer to the second one of the ends 26 relative to the apex 62.

It is also permissible according to some aspects of the present invention for the origin to be disposed at the second end rather than being spaced inward therefrom. That is, the darting edge could permissibly extend all the way from the apex to the second end, with no end band being present.

The first darting edges 52 cooperatively define the first transition segments 44. The second darting edges 54 cooperatively define the second transition segments 46. More particularly, the first darting edges 52 include alternating forward-leaning edges 52a and rearward-leaning edges 52b. When the housing 22 is in the unassembled, flat-sheet form of FIG. 4, adjacent pairs of edges 52a and 52b either define a V-shaped cutout 72 or one of the aforementioned tapered transition segments 44.

Similarly, the second darting edges 54 include alternating forward-leaning edges 54a and rearward-leaning edges 54b. When the housing 22 is in the unassembled, flat-sheet form of FIG. 4, adjacent pairs of edges 54a and 54b either define a V-shaped cutout 74 or one of the aforementioned second tapered transition segments 46.

The edges 52 and 54 are preferably all straight, although alternatively shaped variations fall within the scope of some aspects of the present invention. For instance, curved or segmented edges might be provided, resulting in alternate shapes of the transition regions.

The apices 58 and 62 in the illustrated embodiment are all sharp, triangular, acute apices, in keeping with the preferred straight extension of the edges 52 and 54. However, curved or otherwise alternatively shaped apices (e.g., obtuse, polygonal, etc.) fall within the scope of some aspects of the present invention.

As illustrated, the darting edges 52 and 54 each preferably extend generally longitudinally, or along the pipe axis A or direction of extent when the housing 22 is mounted to the pipe 10. However, in keeping with the changing perimeter of the transition region along the axis A, the darting edges 52 and 54 preferably also angle or slant radially inwardly and outwardly (i.e., extend obliquely) relative to the pipe axis A.

The transition segments 44 are each preferably congruent with one another. Similarly, the transition segments 46 are each preferably congruent with one another. Variations are permissible according to some aspects of the present invention, however.

The transition segments 44 and the transition segments 46 are also preferably congruent with one another. Again, however, variations in size and shape fall within the scope of some aspects of the present invention.

As will be discussed in greater detail below, the transition segments 44 are preferably evenly arcuately distributed about the transition region 36. Similarly, the transition segments 46 are preferably evenly arcuately distributed about the transition region 38. Irregular distributions are permissible according to some aspects of the present invention, however.

The housing 22 also preferably defines first and second pluralities of end band edges 76 and 78, respectively. Each of the end band edges 76 of the first plurality preferably extends from the origin 56 of the corresponding first darting edge 52 to the first end 24. Similarly, each of the end band edges 78 of the second plurality preferably extends from the origin 60 of the corresponding second darting edge 54 to the second end 26.

The first end band edges 76 cooperatively define the first end band segments 48. The second end band edges 78 cooperatively define the second end band segments 50.

In a preferred embodiment, each of the first end band edges 76 extends axially and parallel to the other first end band edges 76 when the housing 22 is mounted to the pipe 10. Similarly, each of the second end band edges 78 extends axially and parallel to the other second end band edges 78.

When the housing 22 is in the unassembled, flat-sheet form of FIG. 4, adjacent pairs of the first end band edges 76 preferably either define a rectangular cutout 80 or one of the aforementioned rectangular end band segments 48. Similarly, adjacent pairs of second end band edges 78 preferably either define a rectangular cutout 82 or one of the aforementioned rectangular end band segments 50.

As noted previously, however, it is permissible according to some aspects of the present invention for either or both of the end bands (and thus the end band edges and end band segments) to be omitted. As also described above, in such an embodiment, the origins of the darting edges would be located at the respective first and second ends themselves.

It is also emphasized that, although the illustrated embodiment features an at least substantially symmetrical housing 22 formed from at least substantially identically sized and shaped tapered transition segments 44 and 46 and end band segments 48 and 50, asymmetries and irregularities fall within the scope of some aspects of the present invention. For instance, some of the first transition segments could be shaped differently than others of the first transition segments, or the first transitions segments could each be larger and differently shaped than the corresponding second transition segments.

When the housing 22 is constructed/assembled/rolled/folded into its final form, as shown in FIGS. 1-3, adjacent pairs of the first darting edges 52 engage one another, as do adjacent pairs of the second darting edges 54. The first transition segments 44 are thus arranged adjacent one another and arcuately about the pipe axis A, as are the second transition segments 46. Even more particularly, the pluralities of tapered transitions segments 44 and 46 are each preferably evenly arcuately distributed about the axis A to cooperatively form the respective transition regions 36 and 38. Uneven distribution and/or irregular shaping of the various transition segments fall within the scope of some aspects of the present invention.

Furthermore, adjacent pairs of the first end band edges 76 engage one another, as do adjacent pairs of the second end band edges 78. The first end band segments 48 are thus arranged adjacent one another and arcuately about the pipe axis A, as are the second end band segments 50. Even more particularly, the pluralities of end band segments 48 and 50 are each preferably evenly arcuately distributed about the axis A to cooperatively form the respective end bands 40 and 42. Uneven distribution and/or irregular shaping of the various end band segments fall within the scope of some aspects of the present invention.

As noted previously, the center band 34 preferably presents a center band perimeter, the transition regions 36 and 38 each preferably present respective transition region perimeters, and the end bands 40 and 42 each preferably present respective end band perimeters. As also noted previously, each transition region perimeter preferably progressively decreases in size from a maximum perimeter equal to that of the center band 34 to a minimum perimeter equal to that of the respective end band 40 or 42.

Alternatively characterized, the housing 22 presents a first perimeter at the first apices 58, a second perimeter at the first origins 56, a third perimeter at the at the second apices 62, and a fourth perimeter at the second origins 60. Provision of the first darting edges 52 results in the first perimeter being larger than the second perimeter. Similarly, provision of the second darting edges 54 results in the third perimeter being larger than the second perimeter.

It is also noted that the origins 56 and 60 in the illustrated embodiment of FIGS. 1-7 are spaced from the respective first and second ends 24 and 26 such that the first end band 40 is defined between the first one of the ends 24 and the second perimeter, and the second end band 42 is defined between the second one of the ends 26 and the fourth perimeter.

Symmetry of the housing 22 is preferably such that the first and third perimeters are preferably at least substantially equal to each other. The first and third perimeters are also preferably at least substantially equal to that of the center band 34. Furthermore, the second and fourth perimeters are preferably at least substantially equal to each other and to the perimeters of the end bands 40 and 42. Again, however, variations in these relationships may be necessary or preferred depending on the configuration of the associated pipe.

Preferably, the end bands 40 and 42 engage the respective ones of the pipe sections 14 and 16 such that the containment region 28 is closed at the ends 24 and 26. It will therefore be understood by those of ordinary skill in the art that it is preferred that the end band perimeters are at least substantially equal to the pipe section outer diameters. (As will be apparent to those of ordinary skill in the art, the thickness of the housing material will inherently result in some variation between the pipe section outer diameters and the end band outer perimeters. However, as will be discussed in greater detail below, the material of the housing is preferably relatively thin. Furthermore, the end bands may also be characterized by their inner perimeters, which are also at least substantially equal to the pipe section outer diameters and do not inherently vary from the pipe section outer diameters as a result of material thickness.)

In a preferred embodiment of the present invention, the housing 22 further defines a circumferential or laterally extending notch 84 or 86 at each respective origin 56 or 60. The notches 84 and 86 define a transition point between the corresponding ones of the darting edges 52 and 54 and the end band edges 76 and 78.

The notches 84 and 86 preferably act as reliefs to aid in folding of the housing 22 and to reduce bulk when the housing 22 is its folded or assembled form. However, it is permissible according to some aspects of the present invention for some or all of the notches to be omitted.

In a preferred embodiment of the present invention, the housing comprises a thin, flexible material.

Reinforcements may be provided in some instances. For instance, reinforcements may in some embodiments be provided along the center band of the housing, either internally or externally or both, to provide additional strength in regions adjacent or in contact with the pipe flange. Alternatively or additionally, reinforcing fibers could be dispersed throughout the housing.

Most preferably, the housing comprising a flexible thermoplastic material that facilitates ease of folding and enables the darting edges 52 and 54 and the end band edges 76 and 78 to be heat sealed to each other.

More particularly, assembly of the housing 22 preferably includes heat shrinking of adjacent pairs of the first darting edges 52 to one another; heat shrinking of adjacent pairs of the second darting edges 54 to one another; heat shrinking of adjacent pairs of the first end band edges 76 to one another; and heat shrinking of adjacent pairs of the second end band edges 78 to one another.

The joined edges 52 and 76 preferably form arcuately spaced apart, generally longitudinal ridges 88 on the exterior of the housing 22. Similarly, the joined edges 54 and 78 preferably form arcuately spaced apart, generally longitudinal ridges 90 on the exterior of the housing 22.

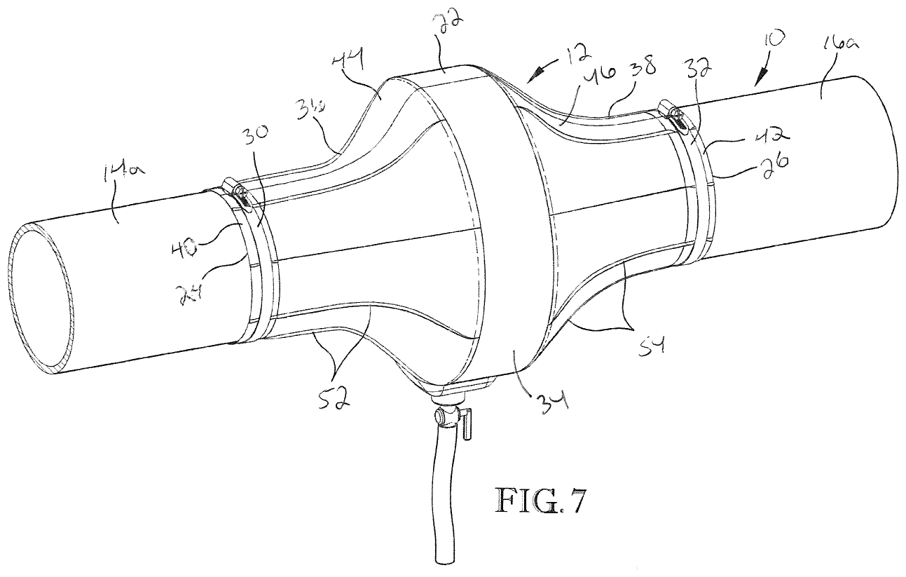

Still further, as shown in FIG. 7 and as will be described in greater detail below, the housing 22 in a broad sense is preferably heat shrunk to itself (to secure itself in wrapped form) and around the connection interface and adjacent portions of the pipe sections 14 and 16.

It is noted that heat shrinking may alter the paths along which the various darting edges 52 and 54 extend. That is, distortion of the material of the housing 22 during a heat shrinking process may result in changes to the shape of the housing 22 and the paths of the darting edges 52 and 54. In the illustrated embodiment, for instance, a nonlinear transition of perimeters occurs as a result of the heat shrinking process, despite the initial linearity of the darting edges 52 and 54.

In a preferred embodiment, and as described briefly above, the end band clamps 30 and 32 preferably circumscribe and at least in part secure the respective end bands 40 and 42 to the pipe section main bodies 14a and 16a. However, it is permissible according to some aspects of the present invention for the end band clamps to be omitted, particularly in embodiments in which other securement forces or features are provided. For instance, in the preferred heat-shrunk configuration, as shown in FIG. 7, at least some amount of securement and sealing is inherently provided via the fit or “shrinking” of the end band material onto the respective pipe sections.

Although it is preferred that end band clamps are provided and that such clamps are, as illustrated, in the form of conventional hose clamps (preferably formed of metal), other forms of clamping devices are within certain ambits of the present invention. For example, according to some aspects, the clamps could alternatively be formed of a cable tie, a self-securing hook-and-loop fastening strap, an adhesive strap, synthetic ratchet-type clamps, or other suitable structure.

Although heat-shrinking of a flexible thermoplastic material is preferred, other materials and/or sealing or joining techniques fall within the scope of some aspects of the present invention. For instance, foil, a semi-rigid synthetic resin, or a metal or metallic material could be used, and/or sealing of the edges could be via use of an adhesive, fasteners, tape, sewing, and/or other elements and methods. The edges could also be temporarily or initially sealed using one of the above techniques, then more securely sealed thereafter via heat sealing.

Techniques that avoid formation of ridges or include removal of any ridges formed during joining also fall within the scope of some aspects of the present invention. For instance, various ridgeless edge-to-edge or overlapping-type connection configurations are permissible.

Heat shrinking of the overall housing after placement could be omitted, as well, without departing from some aspects of the present invention.

Regardless of construction techniques, however, it is preferable that the selected material is at least substantially leak-resistant and more preferably at least substantially leak-proof. The technique for joining the edges likewise preferably produces joined edges that are at least substantially leak-resistant and more preferably at least substantially leak-proof.

### Functionality

In keeping with the above, is preferred that the housing 22 be configured to contain any leakage from the pipe 10 unless such collected leakage is intentionally released therefrom.

For instance, in the illustrated embodiment, the housing 22 defines a drain opening 92 in fluid communication with the containment region 28. The drain opening 92 connects to an outlet tube 94 which is in selective communication with the drain opening 92 as a result of a valve 96. An extension tube 98 is also provided.

The drain opening 92 is preferably defined in the center band 34 in order to be at a low point of the housing 22 and thus be positioned optimally for gravity-assisted drainage. However, alternate positioning falls within the scope of some aspects of the present invention.

As illustrated in FIG. 4, the drain opening 92 is preferably positioned equidistant from the ends 24 and 26. However, the drain opening 92 is not centered between spaced apart edge regions 100 and 102, each of which preferably extends between (and most preferably interconnects) the ends 24 and 26.

For instance, three and one half (3½) of each of the tapered transition segments 44 and 46 are disposed to one side of the drain opening 92, whereas only four (4) of each of the tapered transition segments 44 and 46 are disposed on the other side thereof. As will be discussed in greater detail below, this configuration facilitates overlap of the edge regions 100 and 102 upon securement of the housing 22 about the pipe 10. Various combinations of symmetry or asymmetry of the housing in flat sheet form, including various relative positions of the drain opening, fall within the scope of some aspects of the present invention, however.

Provision of a generally impermeable housing capable of collecting and retaining leaked fluid allows monitoring of the severity of a leak. For instance, at a very basic, qualitative level, one skilled in the art can readily ascertain that a fluid leak that fills the containment region 28 halfway in one hour is far more prolific than one that fills the containment region 28 halfway only after a day has passed. More sophisticated monitoring is possible, as well, with potential add-ons to the system facilitating real-time quantitative monitoring of collected fluid volume and thus real-time leak rate determinations. Alternatively, in an open-drain configuration, add-ons to the system might simply measure flow through the drain opening.

It is noted that that provision of a selectively sealable drain opening allows a user to choose continuous release of any leaked fluids or selective storage of such fluids, followed by controlled release thereof. In some instances, delayed release may be highly beneficial, enabling appropriate disposal or containment solutions to be put in place prior to release of the fluid. For instance, the drain might be connected to a containment drum via a tube, and a flow monitoring device might be mounted to the tube so that the rate of the leak can be monitored.

### Assembly and Installation

In a preferred method of assembly/construction and installation, assembly of the housing 22 preferably initially includes folding together and heat shrinking of adjacent pairs of the first darting edges 52 to one another; folding together and heat shrinking of adjacent pairs of the second darting edges 54 to one another; connecting and heat shrinking of adjacent pairs of the first end band edges 76 to one another; and connecting and heat shrinking of adjacent pairs of the second end band edges 78 to one another. Depending on the type of heat-shrinking equipment used to assemble (heat shrink) the housing 22, such heat shrinking of the housing components may occur sequentially or partially or entirely concurrently.

In the preferred embodiment, the housing 22 is then wrapped about the pipe 10 to at least substantially circumscribe the pipe 10. More preferably, the housing 22 fully circumscribes the pipe 10. However, according to some aspects of the present invention, the illustrated housing 22 in its unassembled or partially assembled form may first be wrapped about the pipe 10 and then heat shrunk.

More particularly, the center band 34 of the housing 22 preferably encircles the flanges 14b and 16b, whereas the transition regions 36 and 38 extend along respective main bodies 14a and 16a of the pipe sections 14 and 16.

The housing 22 is thereafter subjected to a heat-shrinking process that (1) seals the housing 22 to itself such that the housing 22 fully circumscribes the pipe 10 and the pipe 10 extends through the containment region 28 defined by the housing 22; (2) secures the longitudinally opposed ends 24 and 26 of the housing 22 relative to the respective pipe sections 14 and 16 such that a pipe leak location (e.g., in association with the interface 18) is disposed in the containment region 28; and (3) in a broad sense heat-shrinks the housing 22 about the pipe 10.

With regard to sealing of the housing 22 to itself, it is noted that in the illustrated embodiment, such sealing is via securement of the edge regions 100 and 102 to each other to define an overlapping region 104.

Although it is preferred that heat shrinking to one another of the adjacent pairs of the first darting edges 52, the second darting edges 54, the first end band edges 76, and the second end band edges 78 occurs prior to the generalized heat shrinking of the wrapped housing 22, it is noted that such processes may in some instances be performed simultaneously.

It is reiterated that such edges could alternatively be temporarily or initially secured to one another (e.g., with glue, tape, temporary (e.g., heat degradable) stitching, or other suitable means) before wrapping of the housing. The edges could then be permanently or substantially permanently connected via heat sealing in a process simultaneous with that of the overall housing heat-shrinking.

The various effects described above in reference to the post-wrapping heat shrinking process may also in some methods be performed individually or in subsets. For instance, sealing of the housing to itself may occur separately from sealing of the ends to the respective pipe sections.

It is a noted that the step of wrapping the housing 22 about the pipe 10 in the embodiment of FIGS. 1-7 includes wrapping for approximately a single revolution, such that overlapping region 104 of the housing 22 is comparatively small. However, as will be discussed in greater detail below, the housing may alternatively be wrapped for substantially more than a single revolution, resulting in formation of a comparatively large overlapping region.

In a preferred method of installation, the clamps 30 and 32 may be secured to respective ones of the ends 24 and 26 to additionally secure them to the respective pipe sections 14 and 16. Such placement of the clamps 30 and 32 preferably occurs after heat-shrinking of the ends 24 and 26, although pre-shrink placement is permissible according to some aspects of the present invention. For instance, the clamps might be initially used to provide some degree of securement of the ends relative to the pipe sections in preparation for heat-shrinking. The ends may then be more tightly secured via heat shrinking, and the clamps can be re-tightened accordingly to provide still further fixation.

As noted previously, after installation, any leaks from the portion of the pipe 10 disposed in the containment region 28 are preferably contained in the housing 22 except when intentionally released therefrom via the drain opening 92. This enables both qualitative monitoring of the leak (e.g., via visual inspection of how much fluid is captured) and, if additional steps are implemented, quantitative monitoring thereof. For instance, periodic volumetric measurements of collected fluid could be taken and tracked, or real-time flow rate monitoring could be implemented via routing of fluid from the drain through a flow metering apparatus.

### Embodiment 2: Multi-Wrapped with Wrapping Aid and Reinforced Ends

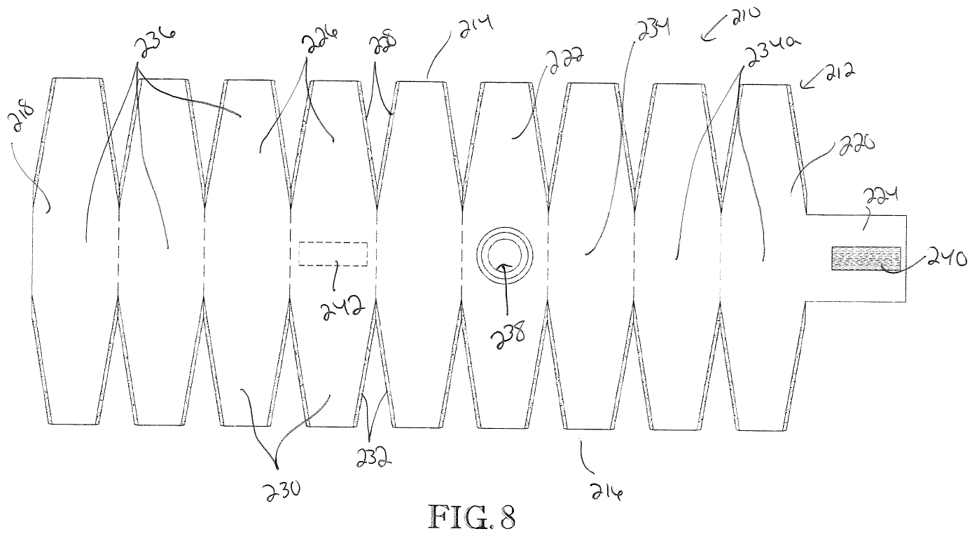

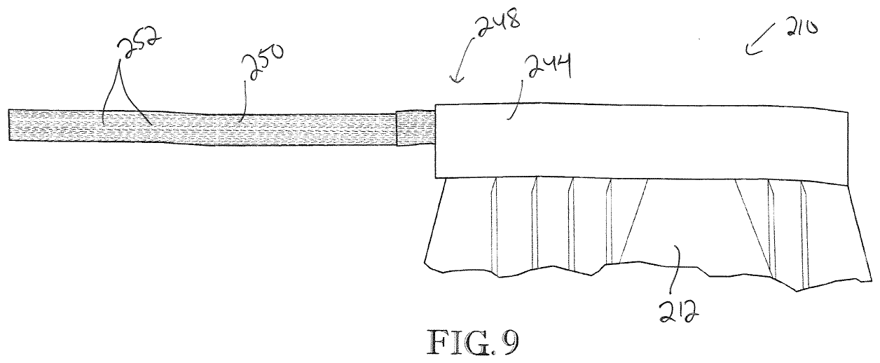

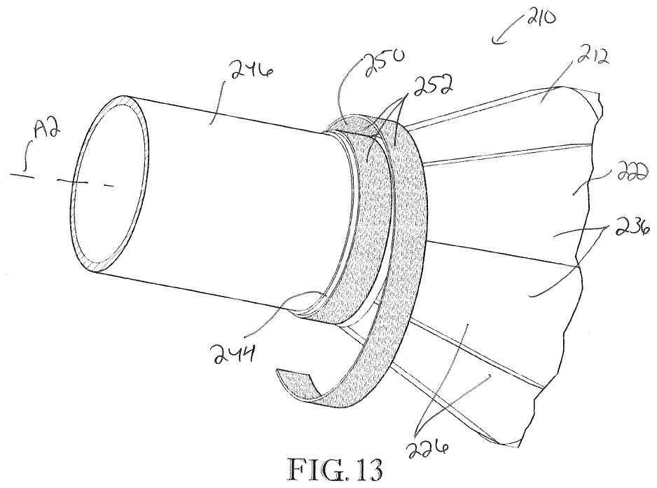

A second preferred embodiment of the present invention is illustrated in FIGS. 8-13. It is initially noted that, with certain exceptions to be discussed in detail below, many of the elements of the pipe leak containment assembly 210 of the second embodiment are very similar to the pipe leak containment assembly 12 of the first embodiment. Therefore, for the sake of brevity and clarity, redundant descriptions and numbering will be generally avoided here. Unless otherwise specified, the detailed descriptions of the elements presented above with respect to the first embodiment should therefore be understood to apply at least generally to the second embodiment, as well.

As shown in FIG. 8, the pipe leak containment assembly 210 preferably includes a housing 212. The housing 212 defines spaced apart ends 214 and 216 and spaced apart edge regions 218 and 220. When the housing 212 is wrapped about a pipe 246, the ends 214 and 216 are preferably longitudinally spaced apart (the longitudinal direction corresponding to a pipe axis A2). The edge regions 218 and 220, in contrast, extend generally longitudinally when the housing 212 is in a wrapped configuration.

Preferably, the edge regions 218 and 220 each extend between the ends 214 and 216. Most preferably, the edge regions 218 and 220 extend between and interconnect the ends 214 and 216.

The housing 212 includes a main body 222 and a tab or tongue 224 extending longitudinally from the edge region 220 of the main body 222.

The main body 222 preferably comprises a plurality of first transition segments 226 that each define a pair of first darting edges 228 and a plurality of second transition segments 230 that each define pair of second darting edges 232. The segments are interconnected to one another via a center band 234.

It is noted that the illustrated housing 212 is devoid of distinct end bands or end band segments, although inclusion of such is permissible according to some aspects of the present invention.

In a broad sense, the housing 212 may be understood to comprise a plurality of housing segments 236, each of which includes corresponding (i.e., longitudinally opposed) first and second transition segments 226 and 230 and a portion 234a of the center band 234 disposed therebetween.

A drain opening 238 is defined in a selected one of the housing segments 236 In the illustrated embodiment, the drain opening 238 is not centered relative to the main body 222 of the housing 212 in its flat or unrolled form. As shown in FIG. 8, for instance, the housing 212 includes five (5) segments 236 to the left of the drain opening 238 and three (3) segments 236 to the right of the drain opening 238. However, centering of the drain opening 238 is permissible according to some aspects of the present invention.

The housing 212 also preferably includes a pair of complementary interengaging elements 240 and 242 configured to secure a first portion of the housing 212 to a second portion of the housing 212. In the illustrated embodiment, for instance, a first element 240 is disposed on the tab 224. A second element 242 is disposed on a housing segment 236. Alternative positioning is permissible according to some aspects of the present invention, and/or additional elements may be provided.

In the illustrated embodiment, the complementary elements 240 and 242 comprise hook-and-loop fasteners. For instance, one of the elements 240 and 242 preferably includes a plurality of hooks, whereas the other of the elements 240 and 242 preferably includes a plurality of complementary loops for receiving at least some of the hooks. However, other interengaging or otherwise connective elements may be used, including but not limited to tapes, glues, or other adhesives. Most preferably, however, such elements are relatively small or low profile to minimize obstruction to the wrapping process or to the housing 212 in wrapped form. Furthermore, the interengagement of the elements is preferably only temporary or at least designed to not interfere with assembly/installation of the housing (which in some cases may involve heat shrinking).

As will be discussed in greater detail below, securement of the housing 212 to itself via the complementary elements 240 and 242 aids in wrapping of the housing 212 about a pipe 246 prior to sealing of the housing or other processes.

The pipe leak containment assembly 210 of the second preferred embodiment of the present invention also preferably includes a pair of flexible reinforcement bands 244 (only one shown), each secured to a respective one of the ends 214 and 216.

Each reinforcement band 244 preferably overlies and is secured to the respective end 214 or 216 prior to wrapping, when the housing 212 is in a flat form. Placement of the reinforcement bands 244 preferably occurs after any housing segments 236 are secured to one other along the darting edges 228 and 232.

Securement may be by heat welding or other means, including but not limited to adhesives. It is also permissible for the bands to each define a slot for receiving the respective end therein, such that the end is sandwiched within the reinforcement band.

Preferably, each reinforcement band 244 is part of reinforcement system 248 that additionally includes a flexible securement or wrapping band or strap 250. More particularly, the reinforcement bands 244 are secured directly to the housing ends 214 and 216, as noted above. Each securement strap 250 preferably extends from the respective reinforcement band 244 when the housing 212 is in the flat configuration. As will be discussed in greater detail below, after the housing 212 has been folded or wrapped onto the pipe 246, such that each reinforcement band 244 circumscribes the pipe 246, each securement strap 250 is wound about the respective end 214 or 216 and, in turn, about the respective reinforcement band 244, and secured.

In the illustrated embodiment, the securement straps 250 are self-securing (e.g., as by self-provided complementary elements 252, such as hooks and loops). Other securement means are permissible, however, including but not limited to adhesives, snaps, tapes, belt loops or buckles, prongs, ratchets, and more.

In the illustrated embodiment, each reinforcement system 248 in a broad sense may thus likewise be understood to be self-securing.

Provision of a cuff or reinforcement band 244 around each end 214 or 216 provides reinforcement prior to clamping of the ends 214 and 216 with a hose clamp or other mechanical element, which protects the less sturdy material of the housing 212 and facilitates tighter sealing via the clamps.

In a preferred embodiment, the band 244 comprises a resiliently deformable or otherwise compressible material. Such compressibility allows for a greater, more impermeable clamping force and resultant seal at each end 214 and 216 of the housing 212.

In a preferred method of assembly and installation, the housing 212 is initially folded together and adjacent pairs of the first darting edges 228 and adjacent pairs of the second darting edges 232 are secured to each other via heat-sealing (or other suitable means).

The reinforcement bands 244 are then heat welded or otherwise secured to the housing ends 214 and 216.

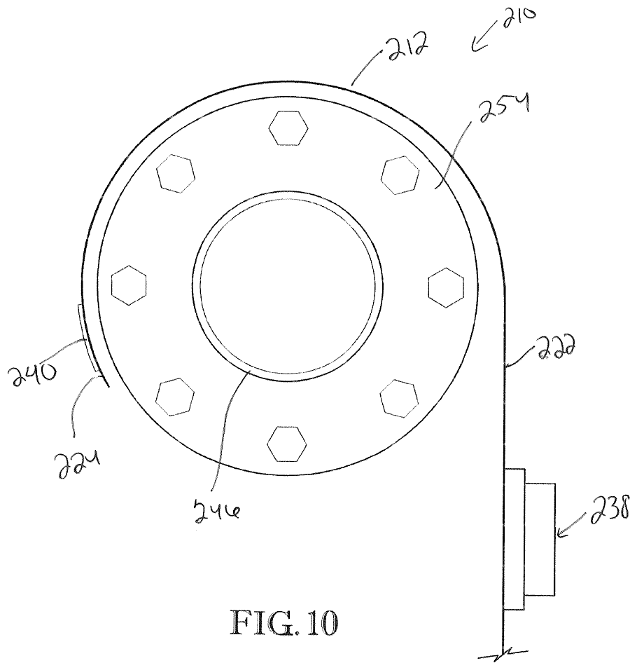

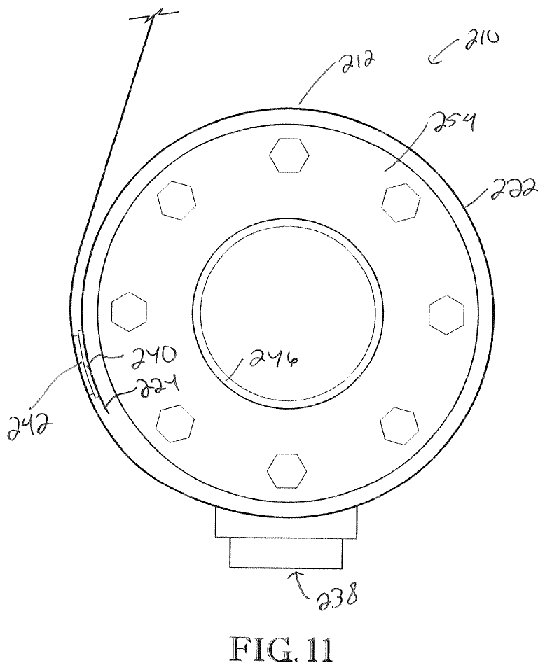

The housing 212 is thereafter wrapped about the pipe 246. More particularly, as shown in FIG. 10, the tab 224 is retained (e.g., manually) relative to the pipe 246 while the main body 222 of the housing 212 is wrapped about the pipe 246. When the housing 212 has made approximately one revolution about the pipe 246, the interengaging elements 240 and 242 are preferably secured to each other to further aid in the wrapping process (see FIG. 11). That is, a housing segment 236 is secured to the tab 224.

More particularly, as shown in FIGS. 10-12, the pipe 246 preferably includes a pair of flange sections cooperatively forming a flange 254. In a preferred methodology, the tab 224 is held by hand against or relative to the flange 254, and the main body 222 is wrapped about the pipe 246 by (another) hand. Other implementations are permissible, however.

Preferably, wrapping of the main body 222 about the pipe 246 is such that the complementary elements 240 and 242 are brought into engagement with each other (see, for instance, FIG. 11). The connection formed therebetween provides initial securement of the housing 212 relative to itself and about the pipe 246 and reduces the risk of the housing 212 simply rotating about the pipe 246 during installation. This feature thereby facilitates single user installation of the assembly 210.

The housing 212 is then wrapped even further about the pipe 246 (i.e., for more than a single revolution) such that an overlapping region 256 of the housing 212 is defined.

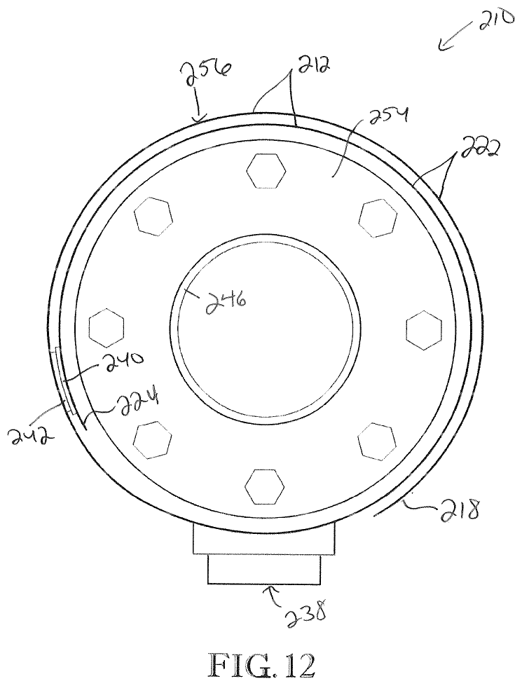

As shown in FIG. 12, it is particularly preferred that the region above a hypothetical horizontal midline of the pipe 246—i.e., over the top of the pipe 246—is double wrapped, such that said region at least in part constitutes the overlapping region 256.

Such double wrapping provides a “splash guard” that ensures that no seams or other potential leakage sources are present above the pipe midline, which in turn ensures that any fluid that escapes the pipe 246 ends up in the bottom portion of the housing 212 (i.e., at or near or in fluid communication with the drain opening 238).

Double wrapping or even additional layers (e.g., triple wrapping) may be provided along any arcuate extent, although as noted previously it is most preferred that that at least the upper one hundred eighty (180) degrees are provided with double wrapping. More preferably, about two hundred seventy (270) degrees are provided with double wrapping. That is, the overlapping region 256 preferably extends arcuately at least one hundred eighty (180) degrees and more preferably extends arcuately about two hundred seventy (270) degrees

It is noted that double wrapping may occur regardless of whether or not a tab is provided, and a tab may be provided in embodiments which do not feature double wrapping.

As a result of the double wrapping, the edge regions 218 and 220 are arcuately spaced apart from one another, in contrast to the overlying nature of the edge regions 100 and 102 of the first embodiment. That is, whereas the overlapping region 104 of the first preferred embodiment is formed exclusively by the edge regions 100 and 102, the overlapping region 256 of the second preferred embodiment extends from the tab 224 to the edge region 219 and is thus cooperatively formed by the tab 224, both of the edge regions 218 and 220, and the portions of the remaining main body 222 of the housing 212. Alternatively stated, the housing 212, and even more specifically, the main body 222 thereof, at least in part overlaps itself.

Wrapping of the housing 212 preferably results in corresponding wrapping of the reinforcement bands 244.

The securement straps 250 of the reinforcement systems 248 are then wrapped securely around the respective reinforcement bands 244 and the pipe 246 and preferably into overlying or overlapping engagement with themselves. The illustrated securement straps 250 are then secured to themselves (e.g., via the hook-and-loop system or other complementary elements 252, as discussed above).

Optionally, clamps (not shown in this embodiment but similar to the clamps 30 and 32 of the first preferred embodiment) may be secured about respective ones of the reinforcement bands 244 and, in turn, about respective ones of the housing ends 214 and 216 and about the pipe 246. Each reinforcement band 244 is thus disposed between the respective clamp and the respective end 214 or 216, and each reinforcement band 244 and the respective end 214 or 216 are secured to the pipe 246.

In a preferred embodiment, each clamp applies a substantial clamping force to the respective reinforcement band 244, which compresses in response and forms a secure seal about the end 214 or 216 and the pipe 246.

The housing 212 may thereafter be subjected to a heat-shrinking process that (1) seals the housing 212 to itself in the overlapping region 256 (including securement of the housing edges 218 and 220 to the main body 222); (2) secures the longitudinally opposed ends 214 and 216 of the housing 212 to the pipe 246; and (3) in a broad sense, heat-shrinks the housing 214 about the pipe 246.

It is noted that, in some methodologies, certain of the above steps may occur in an alternative order. For instance, heat shrinking of the housing in a broad sense might occur prior to application of a clamp.

### Embodiment 3: Discrete Segments

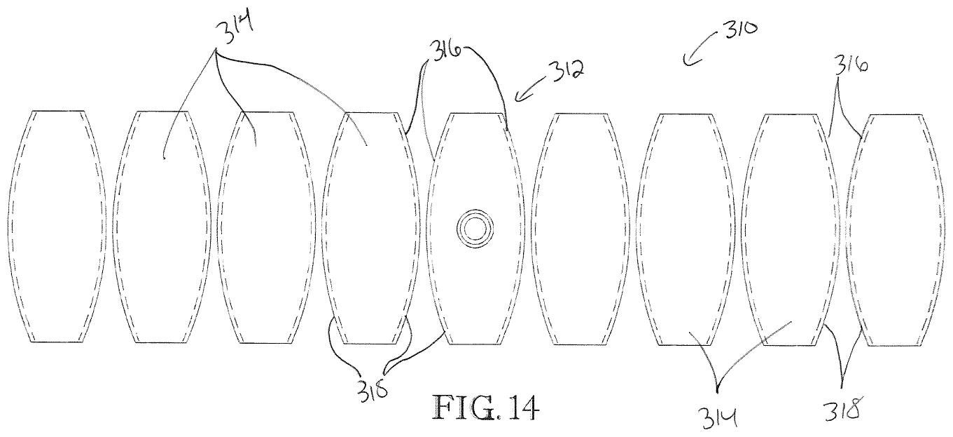

A third preferred embodiment of the present invention is illustrated in FIG. 14. It is initially noted that, with certain exceptions to be discussed in detail below, many of the elements of the pipe leak containment assembly 310 of the third embodiment are very similar to the pipe leak containment assembly 12 of the first embodiment and the pipe leak containment assembly 210 of the second embodiment. Therefore, for the sake of brevity and clarity, redundant descriptions and numbering will be generally avoided here. Unless otherwise specified, the detailed descriptions of the elements presented above with respect to the first and second embodiments should therefore be understood to apply at least generally to the third embodiment, as well.

As shown in FIG. 14, the pipe leak containment assembly 310 preferably includes a housing 312. The housing 312 prior to assembly or construction comprises a plurality of discrete housing segments 314. That is, the housing segments 314 are not initially connected to each other and instead are independently formed.

In a preferred embodiment, each housing segment 314 defines a first pair of darting edges 316 and a second pair of darting edges 318. In the illustrated embodiment, the darting edges 316 and 318 are continuous with each other on each side of the respective segment 314. That is, a distinct center band is omitted, and the corresponding edges 316 and 318 extend along a continuous arc. It is permissible according to some aspects of the present invention, however, for the darting edges to be straight or a combination of straight and arcuate; to be dissimilar from each other or irregularly shaped; and/or to be separated by a central region or band.

Adjacent pairs of darting edges 316 and adjacent pairs of darting edges 318 are preferably configured to be secured to one another in a manner described above with respect to the first and second embodiments.

It is particularly noted that the use of discrete housing segments 314 to construct the housing 312, as opposed to forming the housing from a single sheet as in the first and second embodiments of the present invention, facilitates the use of a thicker material. For instance, whereas the housing 22 of the first embodiment and the housing 212 of the second embodiment might be formed from ten (10) mil material, the housing 312 of the third embodiment, formed from discrete segments 314, may suitably be formed from thirty (30) or even forty (40) mil material.

### CONCLUSION

Features of one or more embodiments described above may be used in various combinations with each other and/or may be used independently of one another. For instance, although a single disclosed embodiment may include a preferred combination of features, it is within the scope of certain aspects of the present invention for the embodiment to include only one (1) or less than all of the disclosed features, unless the specification expressly states otherwise or as might be understood by one of ordinary skill in the art. Therefore, embodiments of the present invention are not necessarily limited to the combination(s) of features described above.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A pipe leak containment assembly operable to contain a leak from a pipe, said pipe including a pair of pipe sections joined at a connection interface, said pipe leak containment assembly comprising:
a housing including a pair of opposed ends defining a containment region therebetween,
each of said ends configured to circumscribe a respective one of the pipe sections, such that the housing is secured relative to the pipe and the connection interface is disposed in said containment region,
said housing defining a first plurality of arcuately arranged darting edges each extending from an origin to an apex, wherein the apex is spaced from a first one of the ends, and the origin is disposed at or nearer to the first one of the ends relative to the apex,
said housing having a first perimeter at the apices and a second perimeter at the origins,
adjacent pairs of said darting edges engaging each other such that the first perimeter is larger than the second perimeter.

2. The pipe leak containment assembly of claim 1,
said darting edges cooperatively defining a plurality of tapered transition segments,
said transition segments being interconnected to each other at the darting edges to cooperatively form a transition region between the second perimeter and the first perimeter,
said transition region defining a transition perimeter that progressively decreases in size from the first perimeter to the second perimeter.

3. The pipe leak containment assembly of claim 2,
said transition region perimeter decreasing in size linearly from the first perimeter to the second perimeter.

4. The pipe leak containment assembly of claim 2,
said transition segments being evenly arcuately distributed about the transition region.

5. The pipe leak containment assembly of claim 1,
said darting edges being straight.

6. The pipe leak containment assembly of claim 1,
said origins being spaced from the first one of the ends such that an end band is defined between the first one of the ends and the second perimeter,
said end band circumscribing the respective one of the pipe sections.

7. The pipe leak containment assembly of claim 6,
said housing further defining a first plurality of arcuately arranged end band edges each extending from the first one of the ends to a corresponding one of the origins,
said end band edges defining a plurality of end band segments therebetween,
said end band segments cooperatively forming the end band.

8. The pipe leak containment assembly of claim 7,
said housing defining a circumferentially extending notch at each origin,
each of said circumferentially extending notches defining a transition point between the corresponding ones of said darting edges and said end band edges.

9. The pipe leak containment assembly of claim 6,
said end band engaging the respective one of the pipe sections such that the containment region is closed at the first one of the ends.

10. The pipe leak containment assembly of claim 1,
said housing defining a drain opening in fluid communication with the containment region.

11. The pipe leak containment assembly of claim 1,
said housing configured to extend along a longitudinal axis corresponding to a pipe axis, such that said opposed ends are longitudinally spaced apart.

12. The pipe leak containment assembly of claim 11,
said darting edges extending generally longitudinally.

13. The pipe leak containment assembly of claim 12,
said darting edges extending obliquely relative to the pipe axis.

14. The pipe leak containment assembly of claim 1,
said housing comprising a flexible material.

15. The pipe leak containment assembly of claim 14,
said housing comprising a thermoplastic material.

16. The pipe leak containment assembly of claim 1,
said adjacent pairs of said darting edges being heat sealed to each other.

17. The pipe leak containment assembly of claim 1,
said housing configured to be formed from a flat sheet.

18. The pipe leak containment assembly of claim 1,
said housing further defining a second plurality of arcuately arranged darting edges each extending from a second origin to a second apex, wherein the second apex is spaced from a second one of the ends, and the second origin is disposed at or nearer to the second one of the ends relative to the second apex,
said housing having a third perimeter at the second apices and a fourth perimeter at the second origins,
adjacent pairs of said darting edges of the second plurality of darting edges engaging each other such that the third perimeter is larger than the fourth perimeter.

19. The pipe leak containment assembly of claim 18,
said darting edges of the second plurality of darting edges cooperatively defining a second plurality of tapered transition segments,
said transition segments of the second plurality of tapered transition segments being interconnected to each other at the darting edges of the second plurality of darting edges to cooperatively form a second transition region between the third perimeter and the fourth perimeter,
said second transition region defining a second transition perimeter that progressively decreases in size from the third perimeter to the fourth perimeter.

20. The pipe leak containment assembly of claim 19,
said housing including a cylindrical center band between said first transition region and said second transition region,
said center band configured to circumscribe the connection interface.

21. The pipe leak containment assembly of claim 20,
said center band being non-segmented.

22. The pipe leak containment assembly of claim 20,
said housing defining a drain opening in fluid communication with the containment region,
said drain opening being defined in the center band.

23. The pipe leak containment assembly of claim 18,
said housing configured to extend along a longitudinal axis corresponding to a pipe axis, such that the opposed ends are longitudinally spaced apart,
said housing being symmetrical across a plane orthogonal to said longitudinal axis and disposed between said opposed ends.

24. The pipe leak containment assembly of claim 1,
said housing being formed from a single sheet,
each of said first plurality of darting edges being defined in said sheet.

25. The pipe leak containment assembly of claim 1,
said housing being formed from a plurality of discrete sheets
each of said sheets defining a pair of said darting edges.

26. The pipe leak containment assembly of claim 1,
said housing configured to extend along a longitudinal axis corresponding to a pipe axis, such that said opposed ends are longitudinally spaced apart,
said housing defining a pair of at least substantially longitudinally extending edge regions extending between the ends,
said edge regions being secured to one another.

27. The pipe leak containment assembly of claim 1,
said housing defining a pair of at least substantially longitudinally extending edge regions extending between the ends,
said edge regions being arcuately spaced apart from one another such that the housing at least in part overlaps itself.

28. The pipe leak containment assembly of claim 27,
said housing including a pair of interengaging elements configured to secure a first portion of the housing to a second portion of the housing.

29. The pipe leak containment assembly of claim 28,
said interengaging elements comprising hook-and-loop fasteners.

30. The pipe leak containment assembly of claim 27,
said housing including a tab extending from one of said edge regions.

31. The pipe leak containment assembly of claim 30,
said housing including a pair of interengaging elements configured to secure a first portion of the housing to a second portion of the housing,
a first one of said interengaging elements being disposed on the tab.

32. The pipe leak containment assembly of claim 1, further comprising:
a flexible reinforcement band overlying one of said ends.

33. The pipe leak containment assembly of claim 32,
said reinforcement band being heat sealed to said one of the ends.

34. The pipe leak containment assembly of claim 32, further comprising:
a flexible securement strap attached to said reinforcement band and configured to secure the reinforcement band relative to the respective one of the pipe sections.

35. A method of containing a leak from a pipe, said method comprising the steps of:
(a) wrapping the housing about the pipe to at least substantially circumscribe the pipe;
(b) sealing the housing to itself such that the housing fully circumscribes the pipe and the pipe extends through a containment region defined by the housing;
(c) securing at least one of the longitudinally opposed ends of the housing relative to the pipe such that a pipe leak location is disposed in the containment region; and
(d) heat-shrinking the housing about the pipe.

36. The method of claim 35,
step (a) including the step of wrapping the housing about the pipe for more than a single revolution, such that an overlapping region of the housing is defined.

37. The method of claim 36,
step (a) including the step of wrapping the housing about the pipe at least one and one half times, such that the overlapping region extends at least 180 degrees.

38. The method of claim 35,
said housing defining a tab,
step (a) including the step of retaining the tab relative to the pipe while wrapping the remainder of the housing about the pipe and the tab.

39. The method of claim 35,
step (a) including the step of securing a first interengaging element disposed on a first portion of the housing to a second interengaging element disposed on a second portion of the housing.

40. The method of claim 39,
said housing defining a tab,
step (a) including the step of retaining the tab relative to the pipe while wrapping the remainder of the housing about the pipe and the tab,
one of said interengaging elements being disposed on the tab.

41. The method of claim 35,
step (b) including the step of securing a pair of longitudinally extending housing edge regions to one another.

42. The method of claim 35,
step (b) including the step of securing a longitudinally extending housing edge region to a main body of the housing.

43. The method of claim 35,
steps (b) and (d) being performed simultaneously.

44. The method of claim 35, further comprising the step of:
(e) prior to step (c), securing a reinforcement band to said at least one of the ends.

45. The method of claim 44,
step (e) including the step of heat sealing the reinforcement band to said at least one of the ends.

46. The method of claim 44,
step (c) including the step of wrapping the reinforcement band about said pipe.

47. The method of claim 46,
step (c) including the step of wrapping the reinforcement band into overlying engagement with itself.

48. The method of claim 46,
step (c) including the step of wrapping a self-securing strap extending from the reinforcement band about the pipe and the reinforcement band, and securing said self-securing strap to itself.

49. The method of claim 48,
step (c) including the step of interlocking a plurality of hooks defined by the self-securing strap to a plurality of loops defined by the self-securing strap.

50. The method of claim 46,
step (c) including the step of securing a clamp about the reinforcement band, said at least one of the ends, and said pipe, such that the reinforcement band is disposed between the clamp and said at least one of the ends and such that the reinforcement band and said at least one of the ends are secured to the pipe.

51. The method of claim 35, further comprising the step of:
(f) securing adjacent pairs of a plurality of darting edges defined by the housing to each other.

52. The method of claim 51,
step (f) including the step of heat sealing the adjacent pairs of darting edges to one another.

53. The method of claim 52, further comprising the step of:
(e) after completion of step (f), securing a reinforcement band to said at least one of the ends.
